(19) United States
(12) Patent Application Publication
(10) Pub. No.: US 2004/0011257 A1
(43) Pub. Date: Jan. 22, 2004

(54) Building materials

(76) Inventor: Ahmad Zolghadri, Tehran (IR)

Correspondence Address: AHMAD ZOLGHADRI, PO BOX 2308, FLAGSTAFF, AZ, 86003, US

(21) Appl. No.: 10/195,627

(22) Filed: Jul. 16, 2002

(51) Int. Cl. C08L 95/00; C04B 9/04; C04B 11/00; C04B 28/14

(52) U.S. Cl. 106/778; 106/277

(57) ABSTRACT

Item A, Gypsum is a valuable building material. Item B, Heavy hydrocarbon emulsion such as bitumen is natural element with long life.

Composition of the items A and B is the actual patent, which has the following properties and advantages. When item A mixed with item B, the mixture will be water proof and the problem of water and moisture is solved. A mixture of item A and B will be a quick setting, while it can be produced and used in any circumstances. Meanwhile setting time of item B is reduced to about quarter of an hour.

Additives to items A and B will be about 50 to 70 percent, which are the essential items in the work process.

Item C, Perlite is an additive with a specific gravity of about two. The volume of this item increase to about 16 times as much, when processed.

### A—PATENT FIELD

Building Materials

### B—PATENT OBJECT

Improvement and remedy of defects of two main items of building material

### C—PATENT APPLICATION

Promote safety factor.

Energy saving.

Preserve environment health.

Recovery merit of material.

Replace hazardous materials.

Useful long life.

### D—PATENT CLAIM

Explanations relevant to application of the two main items and one secondary item reveals that such project or patent is not in practice.

Although the two main items are commonly used and their disadvantages are well-known, the problems in the building industry cannot be continued for ever.

Therefore, considering my explanations personal researches laboratory examinations and practical efforts the actual outcome is concluded to this patent

Patent Introduction

Human has always been in need of accommodation. This need is ever increasing with population growth on the globe. Also, expectations of human for comfort, peaceful life and better environment is increasing day by day.

On this basis considering economy and safety factors in human life good accommodation for dwelling must have the following properties:

1—Easily maintained healthwise.

2—Harmful insects and creatures like termite, scorpion, beetles etc. are not attracted in the house.

3—sound proof against surroundings and neighborhood (the problem of the most buildings in the USA and other places).

4—Weather proof against heath and cold. And being insulated for energy saving.

Note: Insulation must be useful, natural, stable and strong enough.

5—Harmful insulation such as glass wool, Unolite etc are dangerous for human health in case of fire, explosion and dispersion. Therefore, these materials have to be avoided as far as possible in building construction.

6—Building structure must be water proof against rain water, snow and increase of water leakage from pipes or whatsoever.

7—Building must be fireproof, thunder proof, flood proof and earthquake resistant.

Note: If all the situations and properties are achieved in building construction, it will be possible on the basis of my patent to have economical environmental and safety advantages for human.

### Building Structure

1—Item A gypsum is the most valuable building material known in the world. Physical resistance quick setting and other advantages has made this material the best of building materials for easy application and economy. On the other hand the moisture (Direct or indirect) ruins it and shortens its life. This item has been used for centuries but water problem and moisture sensitivity on the material has not been solved yet.

2—Item B—Heavy hydrocarbon emulsion such as bitumen is natural element with long life. Structures with a mix of this item built more than a thousand years ago are still resistant and load bearing, but this item is not quick setting. Setting time depends on the situation of water, temperature and other natural factors which may be 90 days. Bitumen emulsion was used in Iran centuries ago, but since about 50 years ago it is being used in different industries, and slow setting of this material has not been solved yet.

3—composition of the items A and B is the actual patent which has the properties and advantages as described bellow:

3-1—When item A is mixed with item B the mixture will be water proof and the problem of water and moisture is solved.

3-2—A mixture of items A and B will be a quick setting while it can be produced and used in any circumstances. Meanwhile setting time of item B is reduced to about quarter of an hour

Note: Consequently composition of items A and B, apart from elimination disadvantages of these valuable items, will cause production speed to the limit that it can be used along with production.

Additives to items A and B will be about 50 to 70 percent which are the essential items in the work process.

Patent Complementary Plan

Item C—Perlite is an additive with a specific gravity of about two. The volume of this item increases to about 16 times as much when processed. If this item was not available in the country, it can be imported, and as a result of volume increase some employment will be created, Altogether it is a profitable item from economical point of view. Advantage of Perlite is the resistance against harmful and corroding elements and it is recoverable without any pollution. Perlite has a life of more than 500 years. It has no chemical materials. It is light and when processed. It is sound proof as well.

Item C is an integral part of the building material patent even if another additive such as slag is used for economy reasons. Due to the fact that processing of Perlite is an industry by itself for employment reasons, it is considered as the patent complementary plan and it also has other applications other than building constriction.

1. Explanation relevant to application of the two main items and one secondary item reveals that such project or patent is not in practice.
Although the two main items are commonly used and their disadvantages are well known, the problem in the building industry can not be continued forever.
Therefore, considering my explanation, personal research, laboratory examinations and practical efforts, the actual outcome is concluded to this patent.
